(19) United States
(12) Patent Application Publication
(10) Pub. No.: US 2013/0136329 A1
(43) Pub. Date: May 30, 2013

(54) METHOD AND SYSTEM FOR AUTOMATICALLY SETTING A LANDMARK FOR BRAIN SCANS

(71) Applicants: Xiaodong Tao, Beijing (CN); Thomas Kwok-Fah Foo, Clifton Park, NY (US); Robert David Darrow, Scotia, NY (US); Vivek Prabhakar Vaidya, Bangalore (IN)

(72) Inventors: Xiaodong Tao, Beijing (CN); Thomas Kwok-Fah Foo, Clifton Park, NY (US); Robert David Darrow, Scotia, NY (US); Vivek Prabhakar Vaidya, Bangalore (IN)

(73) Assignee: GENERAL ELECTRIC COMPANY, SCHENECTADY, NY (US)

(21) Appl. No.: 13/307,957

(22) Filed: Nov. 30, 2011

(51) Int. Cl. G06K 9/00

(52) U.S. Cl. 382/131

(57) ABSTRACT

A method, system and apparatus for automatically setting a landmark for brain scans are described. In one embodiment, a method for medical image processing is described. The method comprises obtaining, by an imaging device, at least one image of a head of a subject. In addition, the method also comprises identifying, by a computer-based system, a reference feature in the at least one image associated with the head. The method also comprises automatically setting, by the computer-based system, a landmark based, at least in part, upon the reference feature.

### BACKGROUND

Embodiments presented herein relate generally to a field of medical image processing and, more particularly, to a method, system and apparatus for automatically setting a landmark for brain scans.

In medical imaging, such as in magnetic resonance imaging (MRI) and computed tomography (CT) imaging, setting a landmark is a critical step in a process of imaging an anatomical structure such as a head. Based on the landmark, a scan plane and field of view for imaging the anatomical structure is determined. Also, the landmark is used as a reference point in the anatomical structure to determine an extent of coverage of the anatomical structure for generating diagnostic images. In final digital imaging and communications in medicine (DICOM) images, coordinates of a voxel is recorded with reference to this landmark point.

Currently, in medical imaging systems, an operator of an imaging apparatus manually sets a landmark on the exterior anatomical structure such as a head to acquire diagnostic images. For example, the operator approximately aligns the head region to a landmarking laser of the medical imaging system. Further, the operator sets the landmark at a point that the operator considers as a landmark in the head region aligned to the landmarking laser. In another example, the operator may manually place fiducial markers on the exterior anatomical structures. Using the placed fiducial markers, the operator sets the landmark at a point that the operator considers as a landmark in the head region. The landmark set by the operator may be inaccurate. Further, the manual setting of the landmark may be inconsistent with prior landmark settings. Inaccurate and inconsistent landmark settings may lead to loss of important diagnostic values in the diagnostic images. In addition, incorrect landmark positions may lead the system to insufficiently scan a desired anatomical structure. Thus, incorrect landmark positions may lead to longer scans or repeated scans as diagnostic images of the desired anatomical structure does not provide sufficient diagnosis values. For example, in MR scans with parallel imaging, a scout scan that spans a large region of an anatomy of a patient is made as part of a “calibration” scan. If an incorrect landmark position is used, the calibration scan may not sufficiently cover a target anatomical section of interest. Resetting the landmarks to acquire new diagnostic images containing most diagnostic values, results in low efficiency. Furthermore, inconsistencies in manual setting of landmarks between operators and between imaging sessions for the same operator can make calibration scan images or localizers hard to interpret.

What is needed is an automatic and accurate method for determining and setting a landmark for brain scans.

### BRIEF DESCRIPTION

According to one embodiment, a method for medical image processing of an image of a head of a subject is disclosed. The method comprises obtaining, by an imaging device, at least one image of a head of the subject. In addition, the method comprises identifying, by a computer-based system, a reference feature in the at least one image associated with the head region. The method also comprises automatically setting, by the computer-based system, a landmark based, at least in part, upon the reference feature.

According to another embodiment, a system for medical imaging of a head of a subject is disclosed. The system for medical imaging comprises an image capturing device configured to obtain at least one first image of a head of the subject. In addition, the system also comprises a MR scanner configured to obtain at least one second image of the head of the subject. The system also comprises an image processing unit. The image processing unit is configured to analyze at least one first image to identify a first reference feature. In addition, the image processing unit is configured to analyze at least one second image to identify a second reference feature. The image processing unit is also configured to automatically set a landmark based, at least in part, upon at least one of the first reference feature and the second reference feature.

In yet another embodiment, a MRI device for imaging a head of a subject is disclosed. The MRI device comprises an image capturing device configured to capture at least one image of a head of the subject. The MRI device also comprises an image processing module. The image processing module is configured to process the at least one image to identify a reference feature associated with the head of the subject. The image processing module is also configured to automatically set a landmark based, at least in part, upon the reference feature associated with the head of the subject.

### DRAWINGS

These and other features, aspects, and advantages of the present system and techniques will become better understood when the following detailed description is read with reference to the accompanying drawings in which like characters represent like parts throughout the drawings, wherein:

FIG. 1 is a schematic block diagram of magnetic resonance imaging (MRI) system, according to one embodiment;

FIG. 2 is a flowchart illustrating an example process for determining a landmark, according to one embodiment;

FIG. 3 is a flowchart illustrating an example process for setting a landmark in a subject head using an optical image and a localizer image, according to one embodiment;

FIG. 4 illustrates an exemplary process flow for setting a landmark for a human head using a localizer image, according to one embodiment; and

FIG. 5 illustrates an exemplary process flow for setting a landmark for a human head using an optical image, according to one embodiment.

### DETAILED DESCRIPTION

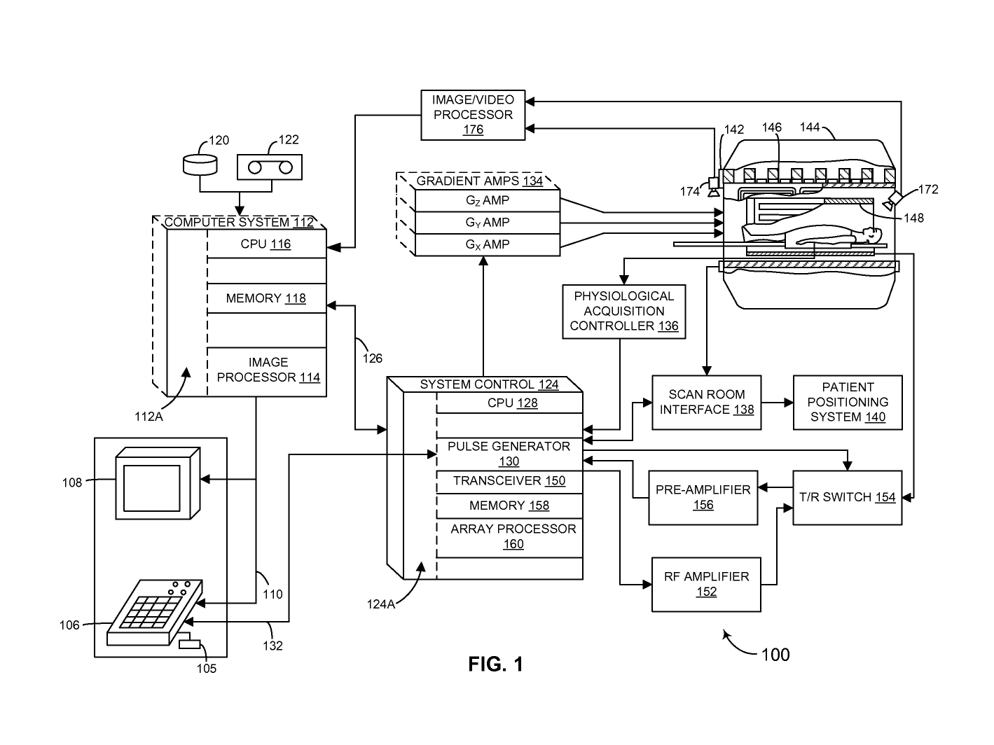

Referring to FIG. 1, various components of an exemplary magnetic resonance imaging (MRI) system 100 benefiting from incorporating the present disclosure are shown. Operation of MRI system 100 is typically controlled from an operator console, which comprises a keyboard or other input device 105, a control panel 106, and a display screen 108. Operator console communicates through a link 110 with a separate computer-based system such as a computer system 112 that enables an operator to control the production and display of images on display screen 108. Computer system 112 comprises a number of modules which communicate with each other through a backplane. These comprises an image processor module 114, a central processing unit (CPU) module 116 and a memory module 118, known in the art as a frame buffer for storing image data arrays. Computer system 112 is linked to disc storage 120 and tape drive 122 for storage of image data and programs, and communicates with a separate system control 124 through a high speed serial link 126. Input device 105 may comprise a mouse, joystick, keyboard, track ball, touch activated screen, light wand, voice control, or any similar or equivalent input device, and may be used for interactive geometry prescription.

System control 124 comprises a set of modules connected together by a backplane 124A. These comprise a CPU module 128 and a pulse generator module 130 which connects to the operator console through a serial link 132. It is through link 132 that system control 124 receives commands from the operator to indicate the scan sequence that is to be performed. Pulse generator module 130 operates the system components to carry out the desired scan sequence and produces data which indicates the timing, strength and shape of the RF pulses produced, and the timing and length of the data acquisition window. Pulse generator module 130 connects to a set of gradient amplifiers 134, to indicate the timing and shape of the gradient pulses that are produced during the scan. Pulse generator module 130 may also receive subject (e.g., patient) data from a physiological acquisition controller 136 that receives signals from a number of different sensors connected to the subject, such as ECG signals from electrodes attached to the subject. And finally, pulse generator module 130 connects to a scan room interface circuit 138 which receives signals from various sensors associated with the condition of the subject and the magnet system. It is also through scan room interface circuit 138 that a subject positioning system 140 receives commands to move the subject to the desired position for the scan.

The gradient waveforms produced by pulse generator module 130 are applied to gradient amplifier system 134 having Gx, Gy, and Gz amplifiers. Each gradient amplifier excites a corresponding physical gradient coil in a gradient coil assembly 142 generally designated to produce the magnetic field gradients used for spatially encoding acquired signals. Gradient coil assembly 142 forms part of the magnet assembly 144 which comprises a polarizing magnet 146 and a whole-body RF coil 148. A transceiver module 150 in system control 124 produces pulses which are amplified by an RF amplifier 152 and coupled to RF coil 148 by a transmit/receive switch 154. Resulting signals emitted by the excited nuclei in the subject may be sensed by the same RF coil 148 and coupled through transmit/receive switch 154 to a preamplifier 156. The amplified MR signals are demodulated, filtered, and digitized in the receiver section of transceiver module 150. Transmit/receive switch 154 may be controlled by a signal from pulse generator module 130 to electrically connect RF amplifier 152 to coil 148 during the transmit mode and to connect preamplifier 156 to coil 148 during the receive mode. Transmit/receive switch 154 may also enable a separate RF coil (for example, a surface coil) to be used in either the transmit mode or the receive mode.

The MR signals picked up by RF coil 148 are digitized by transceiver module 150 and transferred to a memory module 158 in system control 124. A scan is complete when an array of raw k-space data has been acquired in memory module 158. This raw k-space data is rearranged into separate k-space data arrays for each image to be reconstructed, and each of these is input to an array processor 160 which operates to Fourier transform the data into an array of image data. The image data may comprise a two-dimensional (2D) image data, and/or a three-dimensional (3D) image data. This image data is conveyed through serial link 126 to computer system 112 where it is stored in memory, such as disc storage 120. In response to commands received from the operator console, these 2D image data, and/or 3D image data may be archived in long term storage, such as on tape drive 122. These 2D image data, and/or 3D image data may also be further processed by computer system 112 to construct 2D images and/or 3D images respectively. Further these images may be conveyed to the operator console, presented on display 108, communicated to computer system 112 and/or otherwise communicated to a physician or clinician.

The above described procedure for generating images is the same for generating high-speed low quality localizer images (hereinafter referred to as “localizer image”) or high-quality diagnostic images (hereinafter referred to as “diagnostic image”). The localizers may be generated by MRI system 100 at start of examination. The localizer image may be obtained around a location of landmark in an area of interest in short interval of time. In current disclosure, the area of interest is head of a subject. These localizer images may be used for the purpose of initial analysis and/or to set scan plane and field of view for acquiring diagnostic images. The acquired localizer images may be communicated to computer system 112. The localizer images are also known as scout images, locator, scanogram, plan scan, and the like. Diagnostic images are high quality images that have diagnostic values useful for clinical diagnosis.

In one example implementation, MRI system 100 may also comprise optical imaging devices 172-174 (for example, a charge-coupled camera devices) compatible to MRI system 100. Optical imaging devices 172-174 may be configured to capture one or more optical images (for example, pictures) of the head (or face) of the subject. Optical imaging devices 172-174 may be placed to capture one or more optical images of the head (or face) of the subject when the subject is inside magnet assembly 144 and outside magnet assembly 144. Optical imaging devices 172-174 may be communicatively coupled to an image/video processor 176. Image/video processor 176 may process the optical images and/or digitize video signals. The optical imaging device as described herein may be a part of MRI system 100 or electronically coupled to MRI system 100 or independent of MRI system 100. The processed one or more optical images and/or the digitized video signals may be communicated to computer system 112 for further processing.

In one embodiment, computer system 112 may be configured to process localizer images (such as the 2D localizer images and the 3D localizer images) and/or the optical images. Further, computer system 112 may identify a reference feature(s) associated with the head. Using the reference feature(s) associated with the head, an appropriate algorithm may be applied to determine and set a landmark for the head. The landmark may depend on a type of MR exam being performed and/or a type of diagnostic images to be acquired. In one embodiment, the optimal landmark may be set in the middle of desired superior/inferior (S/I) coverage of the head. For example, for a brain scan, the optimal landmark may be a plane through the center of the S/I extent of the brain. In another example, the optimal landmark may be set at the level of glabella.

In one embodiment, based on type of MR exam and/on based on type of diagnostic images to be acquired, computer system 112 may determine and set a landmark. For example, if diagnostic images are for a primary brain exam, computer system 112 may set a landmark at the glabella. Patient positioning system 140 positions the glabella in the isocenter of the magnet (that is, in the region with the greatest magnetic field homogeneity). In another example, if diagnostic images are for MR angiographic exam, then computer system 112 may set a landmark at the level of jaw. This is to ensure that the neurovasculature (internal carotid arteries, cerebral arteries, etc.) as well as the carotid arteries (main and carotid bifurcation) are positioned at the isocenter of the magnet. Computer system 112 may include algorithms that set landmarks based upon the type of examination.

Computer system 112 as described herein may be configured to automatically set accurate and consistent landmark. The landmark for a head may be a location in the head using which the extent of coverage of the head is determined. Unlike anatomical landmarks, the landmark herein refers to a position in a human anatomy in superior to inferior axis. The landmark described herein may or may not be a well defined feature in human anatomy. Upon setting the landmark, the landmark of the head may be aligned to the isocenter of the magnet. Further, computer system 112 may obtain diagnostic images of the head which is aligned to isocenter of the magnet.

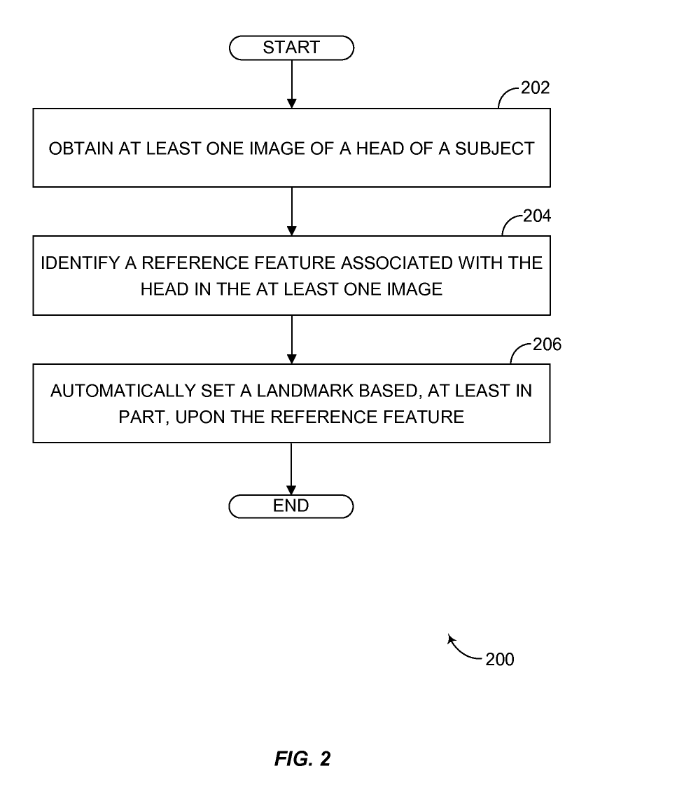

A process of determining and setting a landmark based, at least in part, a reference feature associated with a head is explained in FIG. 2. Although, computer system 112 is discussed in conjunction with MRI system 100 in FIG. 1, one skilled in art can appreciate that computer system 112 may be a standalone device capable of performing methods described herein.

FIG. 2 is a flowchart illustrating an example process 200 for determining a landmark, according to one embodiment. In step 202, at least one image of a head of a subject is obtained through an imaging device. In one embodiment, the at least one image obtained may be a 2D localizer image or a 3D localizer image. The localizer images may be obtained in sagittal plane, coronal plane, axial plane, or in any plane or in combination thereof. Further, any pulse sequence may be used to obtain these localizer images. In another embodiment, the at least one image obtained may be at least one optical image. In yet another embodiment, one or more localizer images and one or more optical images may be obtained. In one example, sagittal image and/or a coronal image may be obtained as the one or more localizer images.

In step 204, a reference feature associated with the head is identified. Computer system 112 may apply suitable image processing algorithm on the at least one image to identify the reference feature associated with the head. Any image processing algorithms using image intensity statistics, for example, maximum intensity or mean intensity etc., to separate signal from noise may be used to identify the reference feature associated with the head. The reference feature may be internal and/or external to the head. For example, the reference feature may be a top of head. Alternatively, the reference feature may be eyebrows. The reference feature may be any definable anatomic space in the head. The reference feature for head may comprise a top of head, eyebrows, and the like. In one example, the reference feature may also be an anatomical landmark, a mathematical landmark or a pseudo-landmark in the head. Examples of the anatomical landmarks that may be used as the reference features may include, but are not limited to, Nasion, a Jugal point, or a Pogonion in face.

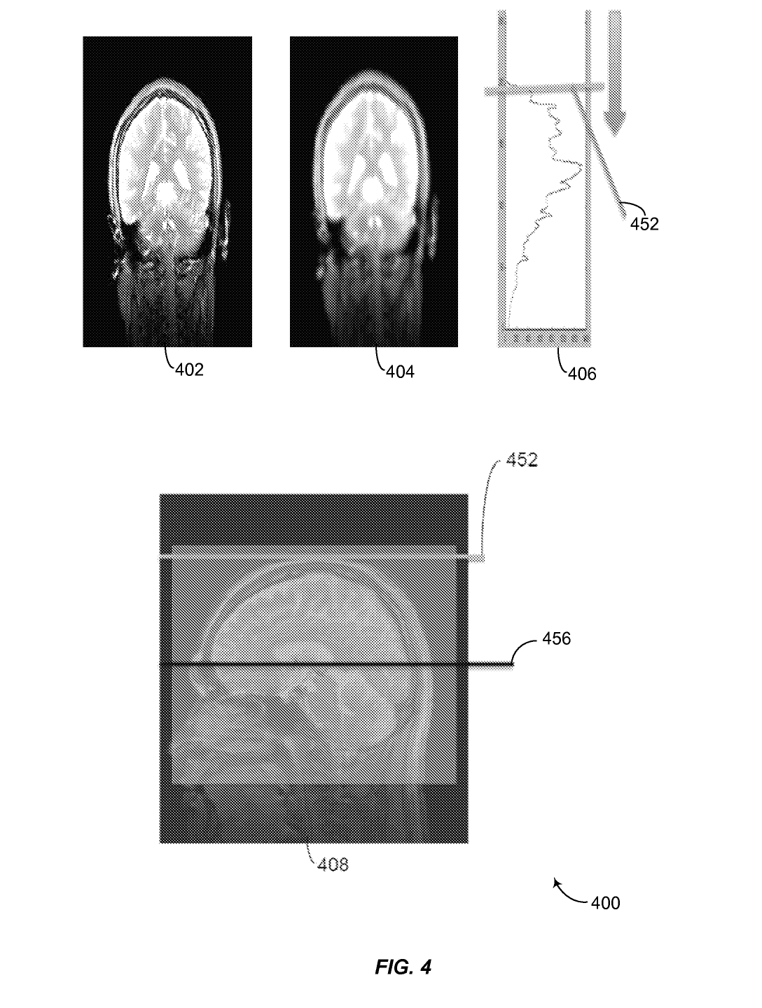

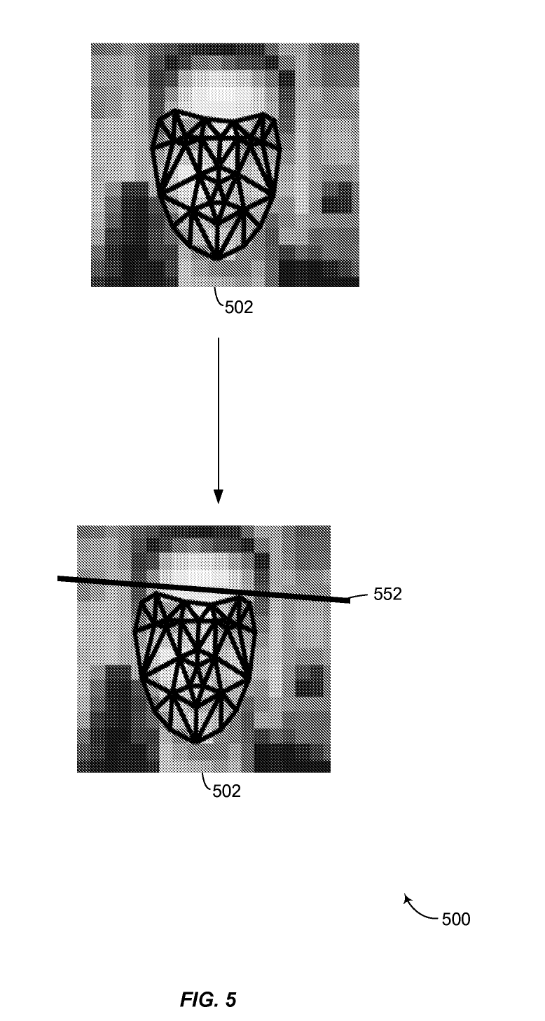

In one embodiment, computer system 112 may process the at least one 2D localizer images or the at least one 3D localizer images to determine a reference feature associated with the head. In another embodiment, computer system 112 may process the at least one optical image to determine a reference feature associated with the head. In yet another embodiment, computer system 112 may process the at least one 2D localizer image, the at least one 3D localizer image and/or the at least one optical image to determine a reference feature associated with the head. Although the disclosure discusses identifying one reference feature, one skilled in the art can appreciate that more than one reference feature associated with the head may be identified. Various embodiments for identifying the reference feature are described in conjunction with FIGS. 4 and 5.

In step 206, a landmark is automatically set based, at least in part, upon the reference feature. Computer system 112 may use the reference feature to calculate an optimal position in the head to be set as a landmark. For example, in brain-scans, computer system 112 may set a landmark in a transversal plane at a pre-determined distance in an inferior direction from the top of the head (the reference feature in this example). Although the disclosure discusses automatically setting a landmark based on a reference feature, one skilled in the art can appreciate that more than one reference feature associated with the head may be used for setting the landmark. In a case, when both the localizer images and the optical images are used, the landmark may be set based on one or more reference features obtained from either or both the image types.

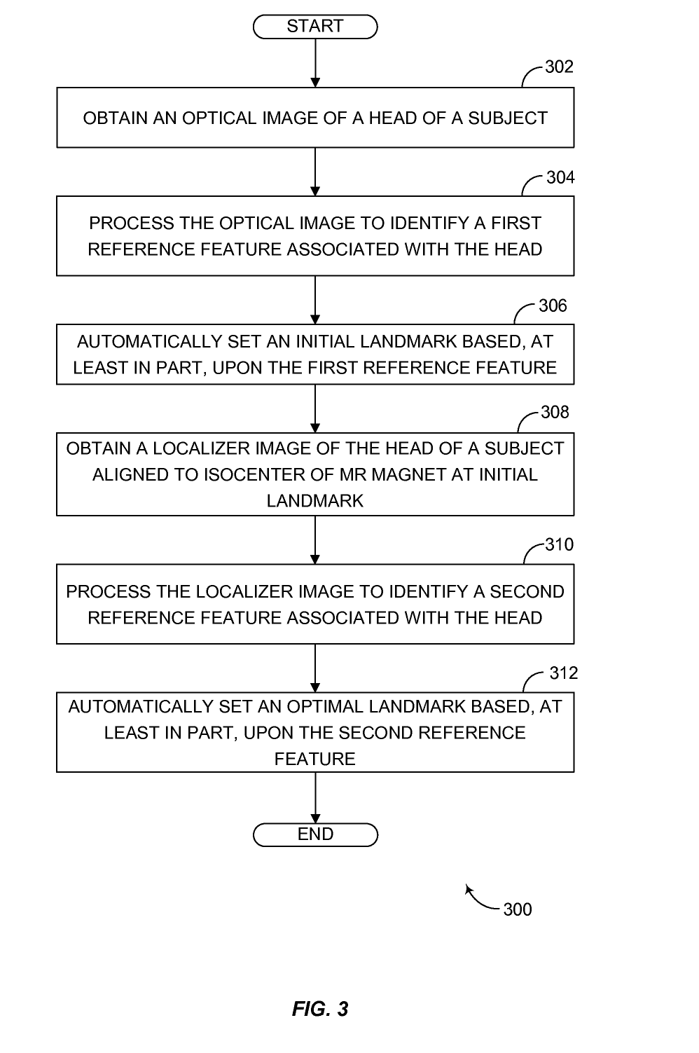

FIG. 3 is a flowchart illustrating an example process 300 for setting a landmark in a head using an optical image and a localizer image, according to one embodiment. In step 302, an optical image of a head (or face) of a subject may be obtained. In one embodiment, the optical image may be obtained by a MR compatible camera of MRI system 100. In another embodiment, the optical image may be obtained by camera coupled to MRI system 100. In yet another embodiment, the optical image may be obtained by an external camera. The optical image may be communicated to computer system 112.

In step 304, the optical image may be processed by computer system 112 to identify a first reference feature associated with the head. Computer system 112 may apply any feature extraction techniques known in the art, for example, active appearance model (AAM) based algorithm to identify the first reference feature. Other feature extraction techniques to identify one or more reference features are contemplated herein. The first reference feature may be exterior to the head. For example, the first reference feature may be a facial feature, such as, eyebrows.

In step 306, an initial landmark may be automatically set based, at least in part, upon the first reference feature. In one example implementation, computer system 112 may set the initial landmark at the pre-determined distance from the first reference feature. Computer system 112 may also use other suitable parameters, for example, tilt of the head, to set the initial landmark. Upon setting the initial landmark, the initial landmark in the head may be aligned to the isocenter of the magnet within magnet assembly 144.

In step 308, at least one localizer image of the head may be obtained at the isocenter of the magnet. In step 310, the at least one localizer image may be processed to identify a second reference feature associated with the head. Upon identifying the second reference feature, computer system 112 may set an optimal landmark based, at least in part, upon the second reference feature, in step 312.

Although the flow chart describes setting an optical landmark by processing the optical image first and the volumetric image later, one skilled in the art can appreciate that volumetric image may be processed first and optical image later to set the optimal landmark.

FIG. 4 illustrates an exemplary process flow 400 for setting a landmark for a human head using a localizer, according to one embodiment. As illustrated in FIG. 4, a two-dimensional cross sectional localizer image 402 of a human head under test may be obtained in a coronal plane (Left/Right direction). Localizer image 402 may include the entire head. In one embodiment, localizer image 402 may be analyzed to determine a location of the head and a size of the head. Based on the size of the head, a location to obtain a second image in another plane (in this example, sagittal plane) may be determined. Further, the second image of the head may be obtained in the another plane. In current example, the second image may be obtained in anterior/posterior direction (for example, sagittal plane).

Localizer image 402 may be processed to reduce noise content in localizer image 402. For example, localizer image 402 may be smoothened to reduce noise in image. One exemplary processed localizer image is illustrated by localizer image 404. Further, a maximum intensity projection may be performed on localizer image 404 to generate a one dimensional profile (for example, one dimensional profile 406). The one dimensional profile may be analyzed to determine a top of head. Optionally, the one dimensional profile may be smoothed before performing the analysis. The top of the head may be determined when the intensity projection in one dimensional profile 406 crosses a predetermined intensity threshold (as illustrated by 452).

Upon determining the top of head, a landmark may be set at a pre-determined distance from the top of head (as illustrated by 456) in S/I axis. In one embodiment, the distance may be calculated based, in part, upon the desired S/I coverage and the size of the head. A landmark may be set at a transversal plane cutting the eyebrows (as illustrated by 408). In current example, localizer image 408 (the second image) obtained in sagittal plane is used to set the landmark. In alternate examples, landmark may be set in localizer image 402, or localizer image 404 or any images (e.g., other images of head in sagittal or coronal planes, or both) associated with head.

FIG. 5 illustrates an exemplary process flow 500 for setting a landmark for a human head using an optical image, according to one embodiment.

As illustrated in FIG. 5, an optical image 502 of the head region (e.g., face) may be obtained. Optical image 502 may be processed to determine one or more reference features. For example, an active appearance model bases algorithm may be used to identify a reference feature in the human face. In current example, the reference feature may be eyebrows. Upon identifying the eyebrows, a location for setting a landmark may be computed. In current example, the location for setting a landmark may be a transversal plane cutting the eyebrows, though the landmark may also be a transversal plane at a pre-defined distance from the eyebrows. For brain-scan cases, the landmark may be an anterior commissure-posterior commissure line at a level of glabella. Further, the landmark may be set at a transversal plane cutting the eyebrows (as illustrated by 552).

Upon setting the landmark, the landmark information may be communicated to patient positioning system 140 by computer system 112. Patient positioning system 140 may move a patient table to align the landmark of the head of the subject to an isocenter (not shown) of a magnet (within magnetic assembly 144). Upon alignment, diagnostic images are obtained for further clinical analysis.

Automatic landmarking may eliminate the need for manual landmarking, thereby streamlining an imaging workflow. Also, the automated landmarking as described herein is configured to automatically determine optimal landmarks with minimal operator intervention. In addition, patient throughput may be improved due to higher efficiency in obtaining images. Although, the disclosure is described in context of MR machine, one skilled in the art can appreciate that the methods described herein may be applied to other imaging technologies like computed tomography (CT) and the like.

The methods disclosed herein may be embodied in the form of computer or controller implemented processes and apparatuses for practicing these processes. These methods may also be embodied in the form of computer program code containing instructions embodied in tangible media, such as floppy diskettes, CD-ROMs, hard drives, and the like, wherein, when the computer program code is loaded into and executed by a computer or controller, the computer becomes an apparatus for practicing the method. The methods may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the method. When implemented on a general-purpose microprocessor, the computer program code segments configure the microprocessor to create specific logic circuits.

While the invention has been described in considerable detail with reference to a few exemplary embodiments only, it will be appreciated that it is not intended to limit the invention to these embodiments only, since various modifications, omissions, additions and substitutions may be made to the disclosed embodiments without materially departing from the scope of the invention. In addition, many modifications may be made to adapt to a particular situation or an installation, without departing from the essential scope of the invention. Thus, it must be understood that the above invention has been described by way of illustration and not limitation. Accordingly, it is intended to cover all modifications, omissions, additions, substitutions or the like, which may be included within the scope and the spirit of the invention as defined by the claims.

What is claimed is:

1. A method for medical image processing of an image of a head of a subject, the method comprising:
obtaining, by an imaging device, at least one image of the head of the subject;
identifying, by a computer-based system, a reference feature in the at least one image associated with the head; and
automatically setting, by the computer-based system, a landmark based, at least in part, upon the reference feature.

2. The method of claim 1, wherein the at least one image is obtained as a localizer image.

3. The method of claim 1, wherein the at least one image is obtained as an optical image.

4. The method of claim 1, wherein processing the at least one image comprises:
performing maximum intensity projection of the at least one image to generate a one dimensional profile of the head; and
identifying the reference feature based on the one dimensional profile.

5. The method of claim 1, wherein the automatically setting the landmark comprises setting the landmark at a pre-determined distance from the reference feature associated with the head.

6. The method of claim 1, wherein the reference feature comprises an exterior feature.

7. A system for medical imaging of a head of a subject comprising:
an image capturing device configured to obtain at least one first image of the head of the subject;
a magnetic resonance (MR) scanner configured to obtain at least one second image of the head of the subject; and
an image processing unit configured to:
analyze the at least one first image to identify a first reference feature;
analyze the at least one second image to identify a second reference feature; and
automatically set a landmark based, at least in part, upon at least one of the first reference feature and the second reference feature.

8. The system of claim 7, wherein the image processing unit is configured to automatically identify an initial landmark based, at least in part, upon the first reference feature.

9. The system of claim 7, wherein the at least one second image of the head of the subject is obtained by using the initial landmark as a reference point for scan.

10. A magnetic resonance imaging (MRI) device for imaging a head of a subject comprising:
an image capturing device configured to capture at least one image of the head of the subject; and
an image processing module configured to:
process the at least one image to identify a reference feature associated with the head of the subject; and
automatically set a landmark based, at least in part, upon the reference feature associated with the head of the subject.

11. The MRI device of claim 10, wherein the image capturing device is an MRI scanner.

12. The MRI device of claim 10, wherein the image capturing device is an MR-compatible camera.
